(19) United States
(12) Patent Application Publication
(10) Pub. No.: US 2009/0094455 A1
(43) Pub. Date: Apr. 9, 2009

(54) Frequency Managed Performance

(75) Inventors: Shon Schmidt, Seattle, WA (US); Todd L. Carpenter, Monroe, WA (US); David James Foster, Bellevue, WA (US); Harjit Singh, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/869,072

(22) Filed: Oct. 9, 2007

(51) Int. Cl. H04L 9/00; G06Q 20/00

(52) U.S. Cl. 713/164; 705/30

(57) ABSTRACT

A computer or other electronic device may use a security module to securely control a system or processor clock to set a predetermined performance level. In an exemplary embodiment, the performance level may be high, medium, or low, supporting a range of application performance requirements. Changes to the performance level may be authorized by a third party presenting cryptographic rights to alter the performance level. Alternatively, postpaid ro pre-paid value may be accumulated at a rate corresponding to the predetermined performance level set by the security module.

### BACKGROUND

Computers are often classified for sale largely based on a maximum performance specification. For example, a computer may be sold with a given processor or bus rate speed. A potential buyer will select a performance level that meets the level of the most demanding program she expects to run. Conversely, due to cost constraints, a buyer may purchase a computer with a less than optimum performance level for the expected tasks. Once purchased, the performance level is locked in.

Manufacturers, on the other hand, wish to meet a variety of price/performance points in a product line in order to appeal to a range of buyers. In past years, manufacturing processes yielded processors and memories with a range of performance that could be sorted and used to manufacture computers and other electronic devices with the desired performance points.

However, in recent years, component manufacturing processes have become more refined. A much higher percentage of components yield into the “top bin” of performance. Manufacturers are then faced with using higher performance parts and permanently reducing their performance to artificially create products at the lower end of the performance range in order to satisfy the demand for lower price/performance products. To compound the inefficiency of such a manufacturing dilemma, when a user with a low performance computer desires higher performance, the user may be required to trade up to a new device or make expensive modifications to improve performance on a device that is really already capable of higher performance. Thus, a computer may be scrapped even though it has untapped performance left.

In other cases, a user may be forced to buy a maximum performance computer even though the highest level of performance is only required for a small percentage of the actual use of the computer.

### SUMMARY

A performance managed computer or electronic device may be adapted to use a security module to control maximum clock rate, allowing adjustable performance of the computer or electronic device. A user may buy such a computer set to operate at a given performance rating. After determining that a higher performance level is desired, the user may simply buy a higher performance level and have the increased performance authorized by a sanctioned party.

To accomplish performance level setting, the security module or secure process may control a clock manager. The clock manager may be capable of changing either a base clock rate or the clock at a processor, bus master, or other critical component.

In one embodiment, the clock rate is relatively fixed, giving a set performance level for a set fee. When a performance change is requested a signal may be sent from an authorized party that sets a different performance level until another request-response transaction. Billing may either be done during the request process or may done at a rate corresponding to the performance level on an on-going basis.

In another embodiment, the clock rate may be changed dynamically. For example, performance may be set in discreet ranges such as high, medium and low and the user charged accordingly for usage at the current level. The performance may be set by the user when anticipating use at a different level, for example, for gaming vs. word processing. The performance may also be set by an application program itself, when a known performance level is pre-set. In this embodiment, a charge scheme for use may incorporate the current performance level in a calculation of consumed value.

As opposed to performance management for transient criteria, such as varying clock rate to control temperature, performance settings with a financial impact may require secure management, even secure management by a remote entity having a trusted relationship with the security module.

### BRIEF DESCRIPTION OF THE DRAWINGS

FIG. 1 is a block diagram showing a system-level view of performance settable computers;

FIG. 2 is a block diagram of showing an electronic device in the form of a computer supporting performance setting;

FIG. 3 is a block diagram of a clock master;

FIG. 4 is a block diagram of an alternate embodiment of a clock master;

FIG. 5 is a block diagram of a representative security module;

FIG. 6 is a flow chart of a method of setting performance in an electronic device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

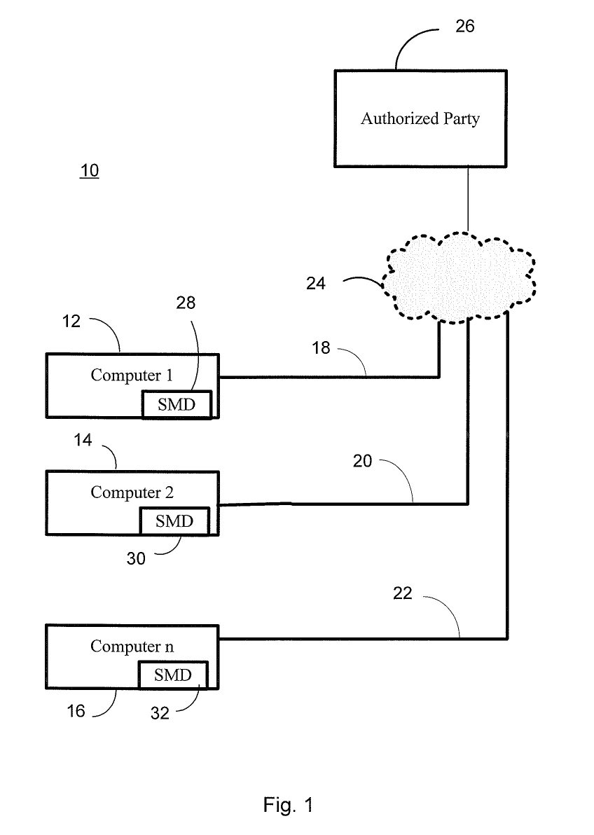

FIG. 1 is a block diagram of a system 10 for managing variable performance computers in a networked environment. In an embodiment where performance level is set by an authorized party 26, representative computers 12, 14, 16 may each have a respective security module 28, 30, 32 that receives messages from the authorized party 26 for setting performance levels. The computers 12, 14, 16 may have individual network links 18, 20, 22 to the authorized party 26 via a local area or a wide area network, such as network 24.

The authorized party 26 may be a manufacturer, a distributor, a dealer, or a specialized agent, such as a leasing company. Individual computers, such as computer 12, may be sold, leased, or provided on a pay-per-use basis. The authorized party 26 may have any number of relationships with the user or owner of representative computer, such as computer 12. In any case, the authorized party 26 may have access to cryptographic keys or a signing authority (not depicted) capable of cryptographically signing the message for setting a performance level. Similarly, the security module 28 for the representative computer should have corresponding keys for authenticating and authorizing messages from the authorized party 26.

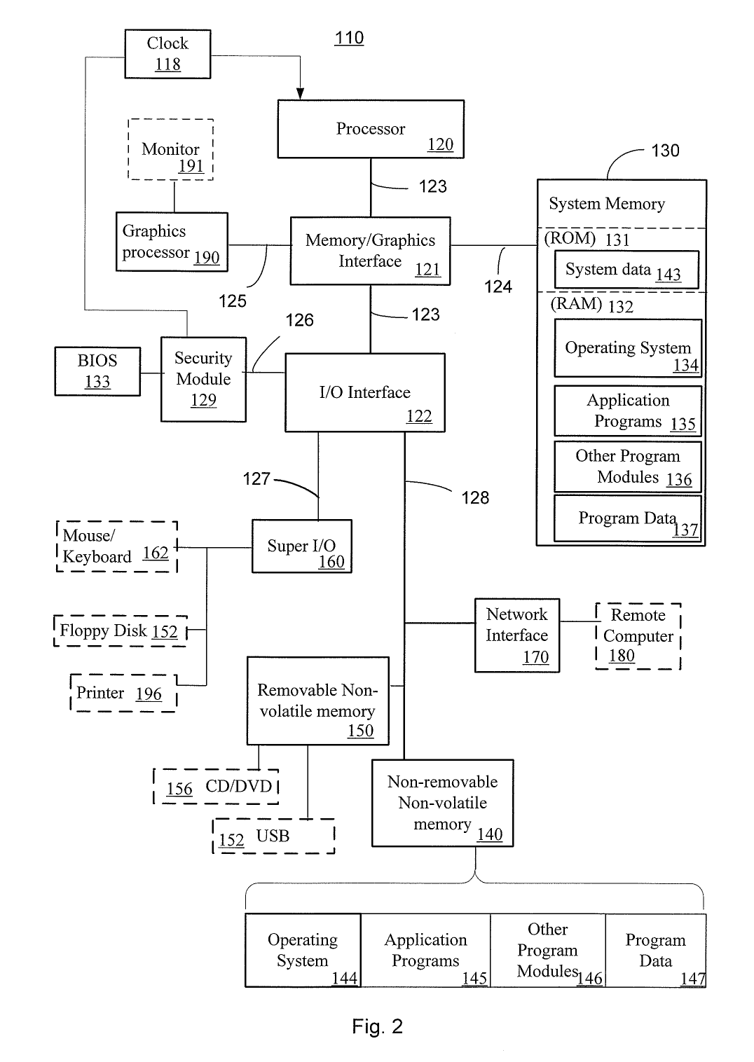

With reference to FIG. 2, an exemplary system for implementing the claimed method and apparatus includes a general purpose computing device in the form of a computer 110. Components shown in dashed outline are not technically part of the computer 110, but are used to illustrate the exemplary embodiment of FIG. 2. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the HyperTransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 2 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

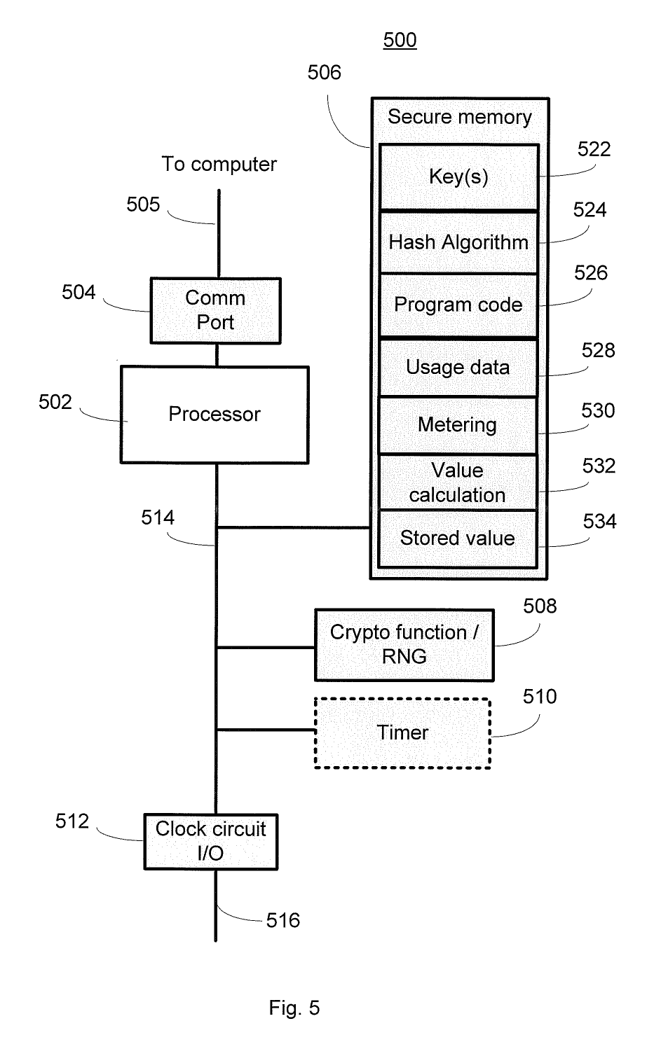

In some embodiments, a security module 129 may be incorporated to manage metering, billing, and enforcement of policies. The security module is discussed more below, especially with respect to FIG. 5.

A clock master 118 may be coupled to the security module 129. The clock master 118 may generate one or more clock signals for use by components such as the processor 120, as depicted in FIG. 2. In other embodiments, the clock master 118 may also provide clock signals to other system components, including, but not limited to, the I/O interface 122, any of the system busses discussed above, etc.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 2 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 110. In FIG. 2, for example, hard disk drive 140 is illustrated as storing operating system 144, application programs 145, other program modules 146, and program data 147. Note that these components can either be the same as or different from operating system 134, an application program 135 or programs, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard/mouse 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

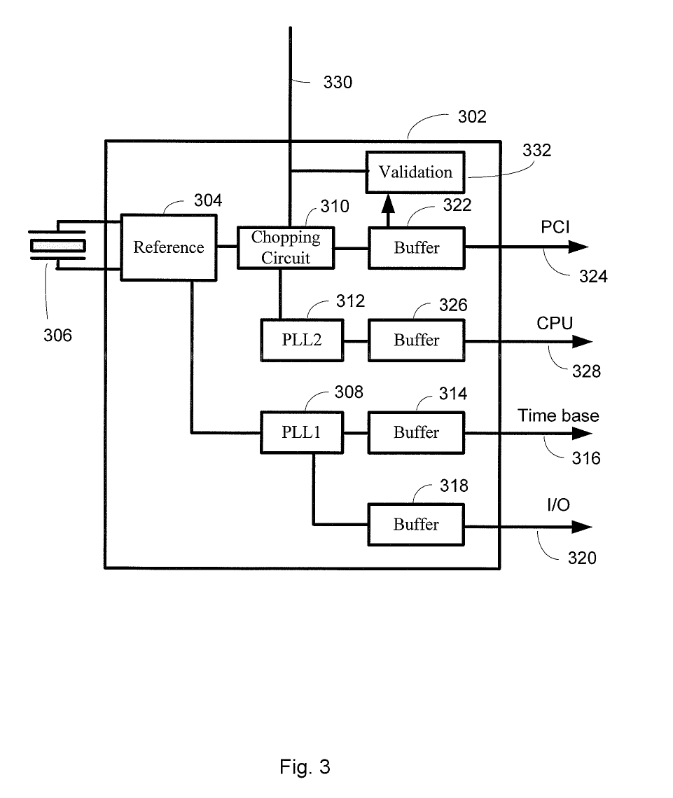

FIG. 3 is block diagram of a clock master 302 that may provide clock data to a number of circuits in a computer, such as computer 110 of FIG. 2. The clock master 302 may have a clock reference 304 that drives an oscillator 306, such as a crystal, that provides a time base or reference frequency. The reference may provide a clock signal to a first phase-locked loop (PLL) 308. The PLL may alter the base clock rate from the reference 304 and provide it to a first buffer 314 that ultimately drives an output, such as a time base output 324 that may be used to synchronize a real time clock (not depicted). A second buffer 318 coupled to the first PLL 308 may provide a clock signal output 320, for example, to an I/O interface 122.

The reference 304 may also drive a chopping circuit 310. The chopping circuit may be an controllable PLL that adjusts an output signal of the reference 304 before passing the output signal through to a third buffer 322 supporting an output clock signal 324 to a bus, for example, PCI bus 128 of FIG. 2. The chopping circuit 310 may also provide a clock signal to a second PLL 312. The second PLL 312 may provide a clock signal to a fourth buffer 326 that has an output 324 driving a processor, for example, processor 120 of FIG. 2.

In other embodiments, the reference 304 may only feed the chopping circuit 310. This may have the effect of allowing the chopping circuit 310 to individually or in unison control all clock signals provided by the clock master 302.

An optional validation circuit 332 may monitor one or more buffers, such as the fourth buffer 326 to determine if the clock signal is actually providing the prescribed signal. Commands to the chopping circuit 310 and output from the validation circuit 332 may be carried over a control bus 330. The validation circuit may be a counter or timer with a number of threshold detectors that trigger at predetermined frequencies. A verification signal indicating the status of each threshold detector may be reported over the control bus 330 to the security module 129, for example. In one embodiment, the control bus 330 may be a serial peripheral interface bus (SPI).

In one operating mode, the clock master 302 may initially run at a predetermined frequency, for example, a low frequency corresponding to a sales price point at the low end of the market. As a user's skills progress a demand for higher performance may arise. The user may contact an authorized party, such as authorized party 26 of FIG. 1, and make arrangements to have the clock master 302 set to a higher performance level. The arrangements may be a one-time payment or change in lease terms, for example. A security module 129 coupled to control bus 330 may send a message to the chopping circuit 310 to increase the output rate to the second phase lock loop 312 and the fourth buffer 326. This may effectively raise the performance of the computer by increasing bus and processor clock rates and therefore their throughput.

In another operating mode, a security module 129 that uses locally stored prepaid or postpaid value to meter usage of the computer 110 may accumulate value at a rate according to the clock master 302 output settings. In one embodiment, the validation circuit 332 may send a signal to the security module 129 to indicate the current clock rate for use and adjusting the corresponding metering rate. In a less secure embodiment, if no validation circuit 332 is present, the security module 129 may assume that the computer 110 is operating at whatever rate was most recently specified. In this operating mode, a user or even an application program, may dynamically specify the clock master 302 output settings. The output settings may be specified either by frequency, or simply as low, medium, or high.

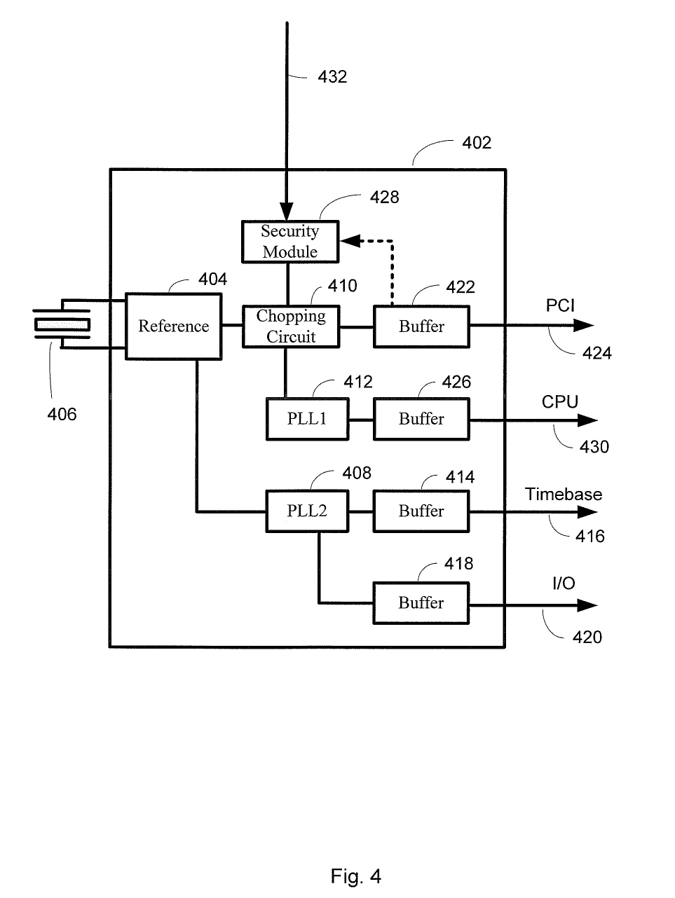

FIG. 4 is a block diagram of another embodiment of a clock master 402. The clock master 402 may be based on a known clock circuit that is used to provide clock signals to a variety of computer components. A reference 404 may be coupled to a crystal 406 or other oscillator to provide a consistent clock signal. The reference 404 may feed a chopping circuit 410 and a phase lock loop (PLL) 408. The chopping circuit 410 may in turn pass a signal to one buffer 422 of a series of buffers 426, 414, 418 used to drive individual circuits, such as a PCI bus 424, a CPU 430, a timebase 416, an input/output circuit 420, etc. The PLL 408 may drive buffers 414 and 418. A second PLL 412 may drive the remaining buffer 426. A security module 428 may be coupled to an outside bus 432.

In operation, the security module 428 may control the chopping circuit 410 to set different clock frequencies to effect varying performance levels for a computer 110 or other electronic device in which the clock master 402 is functioning. Because the security module 428 may have its own processing capability, a separate validation circuit, such as that of FIG. 3, may not be required because the security module 428 can independently verify output clock frequencies, and, if necessary, enforce a sanction when tampering is evident.

Messages received from a user interface, a program requesting a performance level, or an external authorized party may trigger the security module 428 to effect the requested change. In the case of messages from an external party, the security module 428 may cryptographically verify the authenticity of the messages before effecting the requested change. Because clock activity is not changed until verification of the message, attempted denial of service attacks may overwhelm the security module 428 with messages, but may not affect overall clock master 402 activity.

FIG. 5 is block diagram of a security module 500, similar to security module 129 of FIG. 1 or security module 428 of FIG. 4. The security module 500 may have a security module processor 502 and a communication port 504 for communicating with a computer 110 or other host entity (not depicted) over bus 505. The bus 505 may be a PCI bus, an SPI bus, etc., depending on the application. A secure memory 506 may store program code and data. A cryptographic function 508 may provide hardware acceleration to cryptographic functions such as public and private key cryptography and hash operations used for integrity verification. An optional timer 510 may be used for interval verification, or in the case of clock validation as described with respect to FIG. 4, may be used for clock rate validation. An input/output circuit 512 may support communication over a bus 516 with external circuits, for example, the clock master 302 of FIG. 3 or the chopping circuit 410 of FIG. 4. The bus 516 may be a SPI bus, although because of the low data requirements, virtually any bus will suffice.

The secure memory 506 may include key data 522 used for signatures and encryption. A hash algorithm 524 may be used by the security module processor 502 when the cryptographic function 508 is unavailable or inconvenient. Program code 526 may include executable instructions used by the security module processor 502 to perform the normal functions of the security module 500, such as communication. Usage data 528, a metering function 530, a value function 532, and a local stored value account 534 may all relate to local stored value for pay-per-use operation. For example, when usage is metered, usage data 528 may include the clock rate at which the computer 110 is operating. The metering function 530 may be a routine for determining whether the computer 110 is engaged in beneficial use by a user, while the value function 532 may be a routine for calculating the value of on-going use based on the metering 530 and usage data 528 values. The results of the value function 532 may be periodically or continuously subtracted from the local stored value account 534.

When the security module 500 is incorporated into the clock master 402, as depicted by security module 428 in FIG. 4, the security module 500 may not include metering-related functions, if there is another security module, such as security module 129 already performing those functions. In that architecture, with the first security module 129 and a second security module 428, communication between the security modules may be secured and authenticated. When the security module 129 cannot contact security module 428, tampering may be assumed an the security module 129 may impose a sanction such as resetting the computer 110.

The security module 500 may include some or all of a smart card chip, such as those available from Infineon or ST Microelectronics.

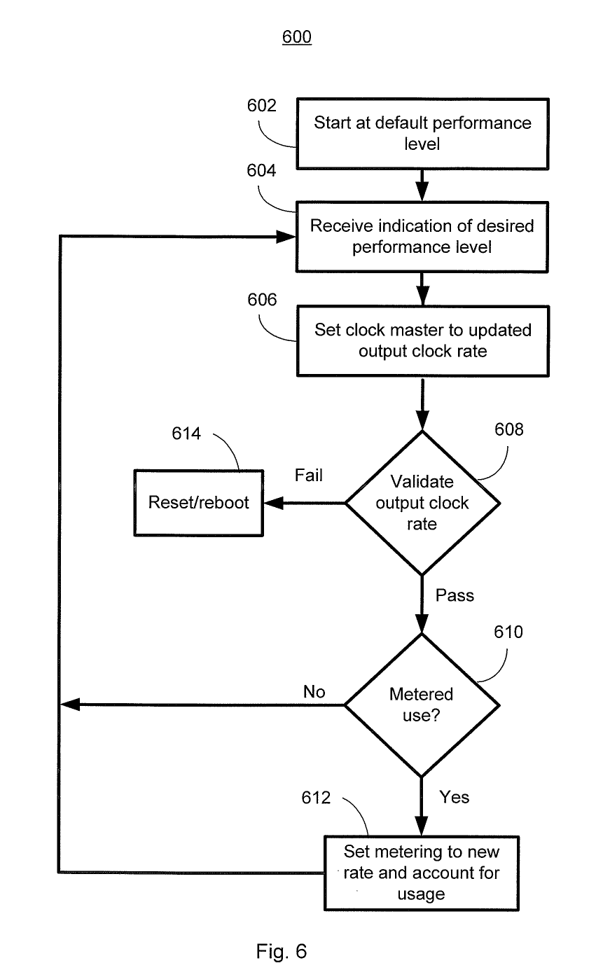

FIG. 6 is an exemplary method 600 of managing performance in a computer. At block 602, an electronic device, such as computer 110, maybe started and operated at a default level of performance. For example, a clock rate corresponding to a low level of performance may be the default value. Alternatively, a default value corresponding to a sales price point may be set at a factory or reseller location.

At block 604, an indication of a desired performance level may be received. In one embodiment, the indication of performance level may be received at a security module, such as security module 129. In another embodiment, the indication of performance level may be received directly at a clock master 402. The indication of performance level may be an input from a user interface, that is, a setting selected by a user.

The indication of desired performance level may also be generated by an application program, for example, a gaming program that requires very high processor speed, graphics controller speed, high bus rates, or a combination of these. When the application program exits, it may send another message indicating that the desired performance is no longer required. A table in the security module 129 or clock master 402 may log which programs have requested given performance levels so that a requesting program will always receive at least its requested level.

In another embodiment, the indication of desired performance level may be an input from an authorized party 26 external to the computer 110. For example, a user wishing to upgrade the performance level of the computer 110 may contact the authorized party 26 and pin upgrade fee. The authorized party 26 may then generate a message including an authorized indication of desired performance level. While this message may ideally be delivered via a network connection, hand delivery via removable media or even entry via keyboard are alternative message delivery mechanisms.

The recipient of the message may authenticate the indication of desired performance level. For example, the security module 129 a cryptographically verify the authenticity and integrity of the message using keys 522 corresponding to the authorized party.

At block 606, a clock master 402 may be programmed to set a clock rate to establish the desired performance level. Because the clock master 402 provides clock signals to virtually all circuitry and buses of the computer 110, the clock master 402 provides an ideal point of control for performance level setting. However, in an alternative embodiment, a clock adjustment circuit may reside in the processor 120 allowing setting of processor performance independently from that of the clock master 402. A continuous range of performance levels corresponding to clock frequencies may be implemented, but in one embodiment, performance level may be set at a fast clock rate, a medium clock rate, and a low clock rate.

At block 608, the output clock rate provided by the clock master 402 may be validated. Such validation may be accomplished, for example, by a validation circuit 332 or a security module 428 incorporated in the clock master 302 or 402 respectively. Alternatively, clock rate validation may be performed on any bus or at any component that may be driven by a clock signal generated at the clock master 302 or 402.

If the clock rate validation fails, the failed branch from block 608 may be taken to block 614 in the computer 110 may be reset or rebooted as a response to potential tampering. If the clock rate validation passes, the pass branch from block 608 may be taken to block 610.

At block 610, is metered operation is not in use, but no branch may be taken from block 610 and the program returned to block 604 waiting for an updated indication of desired performance level. Is metered operation is in use, the yes branch from block 610 may be taken to block 612. At block 612, a metering rate may be adjusted corresponding to the new performance level. Accounting for a usage value may be performed according to the desired performance level and a usage duration. Usage value may be subtracted from a local stored value account or may be accumulated in a postpaid value account which is periodically transferred to a payment system for reconciliation.

The ability to remotely and dynamically set performance level allows manufacturers and resellers to provide computers or other electronic devices across a range of price and performance selling points. Similarly, users are offered computers or other electronic devices at a variety of prices corresponding to performance. As a user's requirements increase the computer or electronic device can be upgraded in place. The manufacturer or reseller can recognize revenue for the upgrade and the user can postpone the cost of a higher performance system until that performance is required. This benefits the user, the manufacturer and reseller, and the environment by expanding the useful life of the equipment.

Similar benefits are realized in a pay-per-use business model where usage is billed at different rates according to the performance level of the computer or other electronic device.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. An electronic device arranged and adapted for metered operation at different performance levels comprising:
a processor;
a clock master coupled to the processor providing clock data to the electronic device;
a security module coupled to the clock master, the security module comprising:
a port for communication;
a security module processor for receiving an desired performance level via the port;
a cryptographic function for verifying an authenticity of the desired performance level; and
a link to the clock master for setting a clock rate for operation of the electronic device to set a performance level to the desired performance level.

2. The electronic device of claim 1, wherein the security module further comprises:
a metering function for determining a usage duration of beneficial use of the electronic device.

3. The electronic device of claim 2, further comprising:
a value function that accumulates value at a rate corresponding to the clock rate and the usage duration.

4. The electronic device of claim 2, further comprising:
a value function that subtracts value from a local stored value account corresponding to the clock rate and the usage duration.

5. The electronic device of claim 1, wherein the security module is incorporated in the clock master.

6. The electronic device of claim 1, wherein the clock master is incorporated in the processor.

7. The electronic device of claim 1, wherein the security module is incorporated in the processor.

8. The electronic device of claim 1, wherein the clock master comprises a chopping circuit that proportionally cuts cycles from a reference to set the clock rate for operation.

9. A method of managing performance in a computer comprising:
receiving an indication of a desired performance level;
setting a clock rate to establish the desired performance level; and
accounting for a usage value according to the desired performance level and a usage duration.

10. The method of claim 9, further comprising authenticating the indication of the desired performance level.

11. The method of claim 9, wherein the indication of the desired performance level is an input from a user interface

12. The method of claim 9, wherein the indication of the desired performance level is an input from an application program.

13. The method of claim 9, wherein the indication of the desired performance level is an input from an authorized party external to the computer.

14. The method of claim 9, wherein accounting for the usage value comprises subtracting value from a local stored value account.

15. The method of claim 9, wherein accounting for the usage value comprises:
accumulating a postpaid value corresponding to the desired performance level and the usage duration; and
transferring the postpaid value to a payment system.

16. The method of claim 9, wherein the desired performance level is one of a fast clock rate, a medium clock rate, and a low clock rate.

17. A clock master for use in a performance managed computer comprising:
an oscillator providing a reference frequency;
a port for communication;
a security module for validating a message received via the port and for setting a clock signal at a frequency specified by the message.

18. The clock master of claim 17, further comprising a validation circuit that confirms the clock signal and sends a verification signal via the port.

19. The clock master of claim 17, further comprising a chopping circuit that sets the clock signal responsive to the security module.

20. The clock master of claim 17, wherein the security module comprises a cryptographic function and a secure memory.
